(19) United States
(12) Patent Application Publication
(10) Pub. No.: US 2020/0272558 A1
(43) Pub. Date: Aug. 27, 2020

(54) AUTOMATED LAYOUT TESTING FOR MOBILE DEVICE APPLICATIONS

(71) Applicant: Microsoft Technology Licensing, LLC, Redmond, WA (US)

(72) Inventors: Richard Li, Sunnyvale, CA (US); Arifulla Shariff, Sunnyvale, CA (US); Venkatesan Sundramurthy, Santa Clara, CA (US); Srikanth Guduru, Mountain View, CA (US)

(21) Appl. No.: 16/282,153

(22) Filed: Feb. 21, 2019

(51) Int. Cl. G06F 11/36; G06F 9/445

(52) U.S. Cl. CPC G06F 11/3684; G06F 9/44526; G06F 11/3664; G06F 11/3692; G06F 11/3688

(57) ABSTRACT

In an embodiment, the disclosed technologies include a code generator software that receives digital data that identifies a layout file and a test schema and automatically creates, using the layout file and the test schema, machine-readable code representing tests. The layout file includes runtime specifications for a particular user interface. The test schema identifies inputs to be used to test renderings of a plurality of different user interfaces. The tests are executable to validate a rendering of the particular user interface by a mobile device operating system. The code generator software generates the computer code by mapping the inputs to the runtime specifications.

### TECHNICAL FIELD

The present disclosure relates to the technical field of automated testing tools for mobile device software.

### BACKGROUND

A mobile device platform provides a suite of tools that enables software developers to create applications to run on the platform. The suite of tools often includes a standard set of user interface elements as well as pre-defined arrangements of those elements.

A developer can define the visual structure of a user interface and its underlying functionality by writing code in a machine readable language. For example, the developer may design the visual aspects of a user interface by creating a layout file using a markup language such as XML (eXtensible Markup Language).

Prior to deployment, the behavior of a user interface needs to be stress-tested using a variety of inputs in order to verify its proper operation in response to many different conditions. Existing automated testing tools have limited functionality. For example, some existing tools are only capable of black-box testing. Black-box testing is performed by a tester who does not have knowledge of the underlying code structure or implementation details. Black-box testing cannot ensure that all possible paths through the code have been tested. Other known automated testing tools are not suitable for layout testing or are limited to use with particular platforms.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram of a process, in an embodiment;

FIG. 2 is a block diagram of a software-based system, in an embodiment;

FIG. 3 is a block diagram of a networked computing environment, in an embodiment;

FIG. 4A and FIG. 4B are examples of machine-readable code, in an embodiment;

FIG. 5 is a block diagram that illustrates a hardware environment upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

General Overview

In an embodiment, digital data that identifies a layout file and a test schema are received by a code generator software. The layout file includes runtime specifications for a particular user interface. The test schema identifies inputs that can be used to test renderings of multiple different user interfaces. The code generator software uses the layout file and the test schema to automatically create machine-readable code. The machine-readable code represents tests that can be used to validate a rendering of the particular user interface.

In an embodiment, the layout file includes runtime specifications for a particular user interface that is designed for a mobile device application. In an embodiment, the code generator software generates the computer code by mapping the inputs provided by the test schema to the runtime specifications provided by the layout file.

Some embodiments of the disclosed technologies can be used to auto-generate white-box tests for user interface layouts. Certain embodiments auto-generate white box layout tests for specific mobile device platforms, including but not limited to the ANDROID operating system.

White-box testing is performed by a tester (whether a human or an automated agent) that has access to or knowledge of the underlying code structures and implementation details. White-box testing therefore can be used to test the coverage of code statements, branches, paths and conditions against various edge cases, to make sure that all conditions and code paths are tested. This type of analysis cannot be performed by automated black-box testing techniques, since code statements are not exposed to the black-box tester.

The disclosed technologies can improve the consistency and robustness of layout testing processes by, for example, using a test schema that has been designed to provide a requisite level of layout testing across multiple different layouts and/or views. Use of a test schema that is applicable to multiple different layouts and/or views can remove the need to generate (either manually or by an automated process) separate tests for each individual layout, view, or test. Use of a test schema can thereby reduce the number of similar or redundant test cases in a code base while improving overall code quality by ensuring that similar user interface elements, views and layouts are subject to the same level of testing across a project or an organization. Moreover, the disclosed technologies can improve software build processes by removing the need for tests to be manually written.

The disclosed technologies are not limited to the above advantages. Other advantages may be realized by any one or more embodiments of the disclosed technologies.

Process Overview

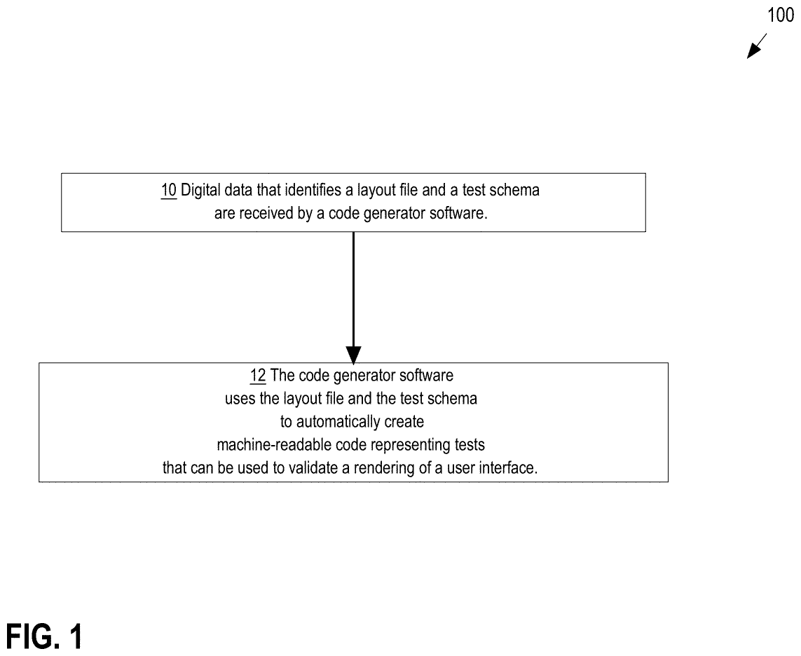

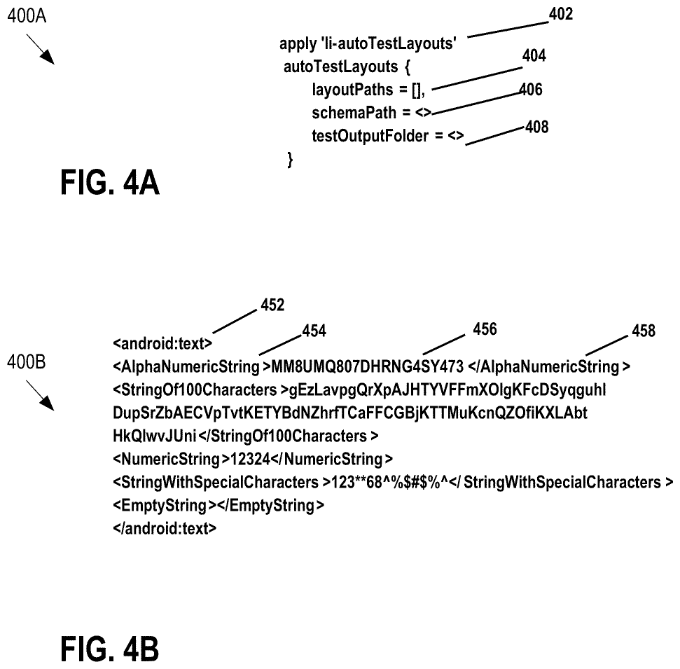

FIG. 1 is a flow diagram that depicts a process 100 that can be performed by an automatic code generator system, in an embodiment. Portions of process 100 may be performed by a single entity or program or by multiple entities or programs, including for example a plug-in and a server computer. In an embodiment, portions of process 100 may be implemented as a plug-in to a build automation tool such as GRADLE. As such, the operations of the process as shown in FIG. 1 can be implemented using processor-executable instructions that are stored in computer memory. An example of a plug-in that may embody portions of process 100 is shown in FIG. 4A, described below.

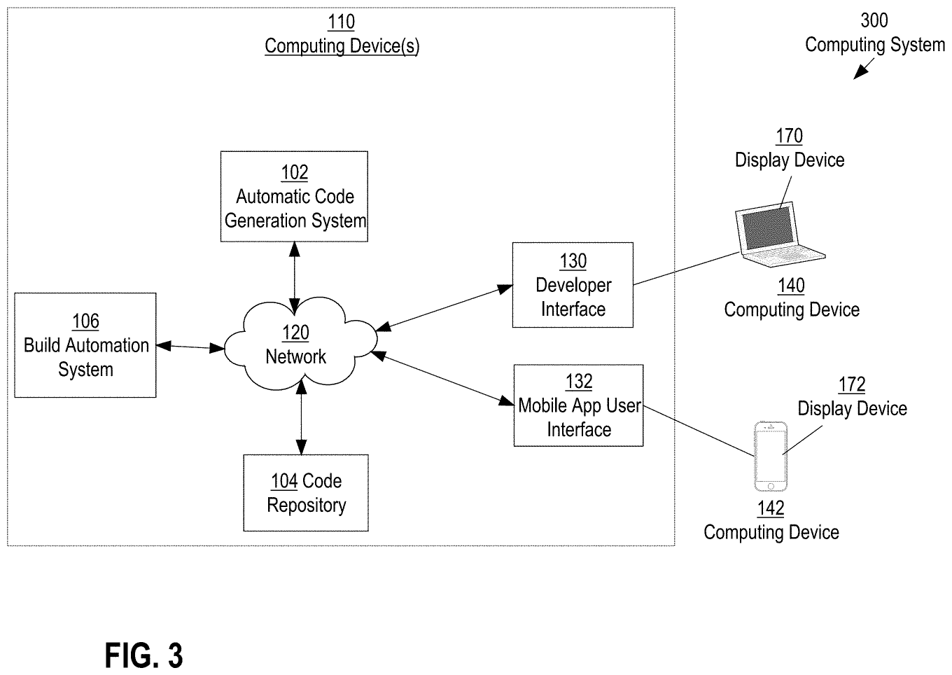

For purposes of providing a clear example, the operations of FIG. 1 are described as performed by computing device(s) 110, 140 of FIG. 3, which may be individually or collectively referred to as simply ‘computing system 300.’ In an embodiment, portions of process 100 may be implemented in machine-readable instructions of automatic code generation system 102 alone or in combination with code repository 104 and build automation system 106 of FIG. 3.

In operation 10, process 100 receives digital data that identifies a layout file and a test schema. In an embodiment, the layout file is a particular layout file that defines visual characteristics of a user interface for a particular software application. In an embodiment, the particular software application is a mobile device app. In an embodiment, the particular software application is an app that is configured to run on a particular mobile device platform such as the ANDROID operating system.

The layout file includes runtime specifications for a user interface. In an embodiment, the layout file includes specifications for graphical user interface elements, attributes of elements, arrangements of elements, views, arrangements of views, sequences of views, and expected behaviors of elements and views. For example, a layout file may specify the color of a button and conditions under which the color is to change to a different color. As another example, a layout file may specify a temporal or spatial ordering of views including whether a view should or should not overlap with another view under certain conditions. In an embodiment, the layout file is stored electronically in a code repository such as code repository 104 of FIG. 3, described below.

“Element” as used herein may refer to a particular graphical user interface element or an arrangement of such elements, and may include a combination of interactive and non-interactive elements. As such, the term “element” as used herein may refer to, for example, a layout, a view, a group of elements, or an individual element such as a text box, label, on-screen graphic, or button.

In an embodiment, operation 10 includes extracting, from the layout file, digital data that identifies one or more testable elements. The testable element(s) can include any one or more of the following: a view, a spatial arrangement of views, a temporal order of views, a graphical element, an interactive element, an attribute of a view, an attribute of a graphical element, an attribute of an interactive element.

The test schema identifies test types and inputs to be used to test renderings of one or more user interfaces. In an embodiment, the test schema is not applicable only to a single particular user interface but can be used to automatically generate tests for multiple or even many user interface layouts, views, or elements of the same type. For example, a test schema may specify a test type and corresponding inputs to be used to test a particular type of layout, view, or element under different conditions, where the inputs are configured to test various different paths through the user interface code. There may be a set of layouts or a set of views, or a set of elements, that corresponds to a particular test type such that a test schema that identifies the test type can be applied to any layout or view or element in the set.

In an embodiment, the test schema contains digital data that identifies an element type (such as a type of view), a test type associated with the element type, and an input associated with the test type. An example of a test schema, including an element type, test types, and inputs, is shown in FIG. 4B, described below. In an embodiment, the test schema are files that are stored electronically in a code repository such as code repository 104 of FIG. 3, described below.

In operation 12, process 100 uses the layout file and the test schema to automatically create machine-readable code representing tests that can be used to validate a rendering of a user interface. In an embodiment, operation 12 automatically creates machine-readable code representing tests by reading data from the layout file and the test schema. For example, operation 12 creates the machine-readable code using, as input parameters, digital data that has been read or extracted from the layout file and digital data that has been read or extracted from the test schema. The tests created by operation 12 are executable to validate the rendering of the user interface; for example, to verify that the visual appearance of the user interface matches an expected visual appearance in response to various types of inputs. To generate the computer code, operation 12 maps the inputs that have been extracted from the test schema to the runtime specifications extracted from the layout file, in an embodiment.

In an embodiment, operation 12 receives as parameters the digital data that identifies the plurality of testable elements of the layout file and maps one or more of the parameters to the element type of the test schema. In an embodiment, operation 12 is implemented as part of a plugin for a build process; for example, a build process operated by build automation system 106 of FIG. 3, described below.

In an embodiment, operation 12 identifies an application program interface (API) associated with a mobile device operating system and generates a test that includes a command that uses the API to obtain current state data from the mobile device operating system, and then analyzes the current state data to determine whether the test has been completed successfully.

In an embodiment, the tests created by operation 12 are executable to, using the inputs identified in the test schema, validate, for the layout file, on-screen characteristics of the user interface including but not limited to any one or more of the following: a visual appearance of an element, a size of an element, a shape of an element, a location of an element, an international compatibility of an element, a color blind compatibility of an element.

In an embodiment, portions of process 100 are implemented as a network service that accesses a code repository to obtain or access the layout file and the test schema. In an embodiment, portions of process 100 are configured for compatibility with a particular mobile device operating system, for example, any one or more of the following: an open source operating system, an ANDROID operating system, an iOS operating system.

Example Arrangement of Software Components

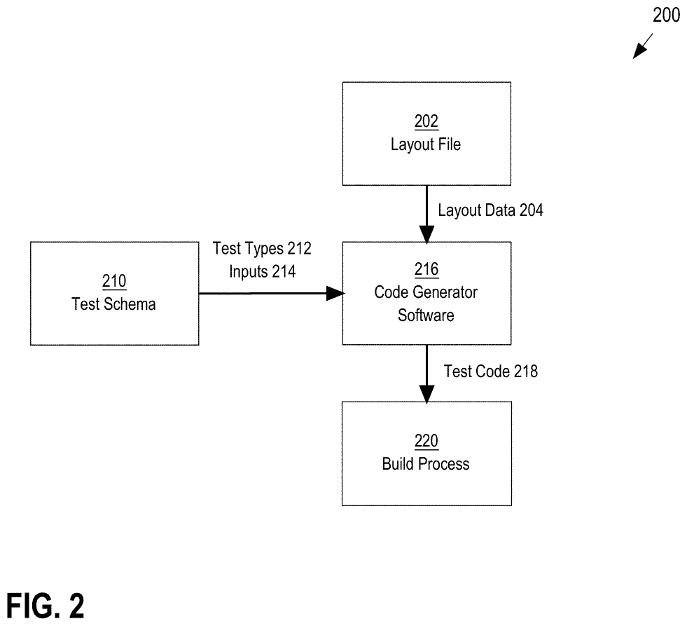

FIG. 2 is a block diagram that depicts an example system 200 for automatically generating tests using the disclosed technologies, in an embodiment. The software-based components and data of the system of FIG. 2 include layout file 202, layout data 204, test schema 210, test types 212, inputs 214, code generator software 216, test code 218, and build process 220.

Layout file 202 is an electronic file that contains digital data and metadata that indicates visual characteristics and visual behavior of a user interface in response to various input conditions. In an embodiment, layout file 202 is implemented using a markup language such as XML. Layout data 204 is digital data that is read or extracted from layout file 202, for example by code generator software 216. Layout data 204 can be extracted from layout file 202 using, for example, a parser such as an)ML parser. Layout data 204 identifies testable elements of the layout file 202. Layout data 204 includes definitions of views, elements, and attributes of views and elements. Illustrative, non-limiting examples of layout data 204 used as input to code generator software are shown in the first column of Table 1, below.

Test schema 210 is one or more electronic files that contain digital data that indicates test types and inputs (e.g., test cases) for one or more types of elements, views, or layouts. An example of a test schema is shown in FIG. 4A, below. Either or both of layout file 202 and test schema 210 may be created for example by a computer programmer or a team of computer programmers, or by an automated agent.

Test types 212 and inputs 214 are read or extracted from test schema 210, for example by a parser that can read test schema 210 (e.g., a JAVA parser or)ML parser). A test type 212 identifies a type of graphical user interface element to which the test inputs 214 are applicable; for example, a text field. Test inputs 214 include, for example, strings of alphanumeric characters that are configured to stress-test a particular path (or paths) through the user interface code to make sure that the user interface responds to the inputs 214 as expected.

Code generator software 216 receives layout data 204, test types 212, and inputs 214, and using these parameters, automatically generates test code 218. To do this, in an embodiment, code generator software 216 maps the layout data 204 to the test types 212 in order to determine which test types 122 apply to the layout file 202. Using the applicable test types 212 and the corresponding inputs 214 that are specified in the test schema 210, code generator software 126 generates the test code 218 for the layout file 202.

Test code 218 includes machine-readable code that can be executed by one or more processors in conjunction with a runtime operation of the user interface that is defined by layout file 202. In an embodiment, test code 218 contains a set of programming statements, for example assertions in the JAVA programming language, which are designed to test the reaction of the user interface to the various inputs specified by the test schema. API calls to the operating system running the test instance of the user interface are inserted into the test code 218 in order to, during operation of the test, obtain current system state data. In operation, test code 218 evaluates the current state data by comparing the current state data to expected system state data. Test code 218 obtains the expected state data from, for example, layout file 202. As test code 218 is automatically generated by software 216, there is no need for tests to be written manually.

Table 1 below provides illustrative, non-limiting examples of layout data that may be input to code generator software 216, as well as test code that may be output by code generator software 216 in response to the input, and an explanation of the purpose and applicability of the automatically generated test.

TABLE 1
Test Examples.

| Layout data | Test (code generator output) | Purpose | Applicability |
|---|---|---|---|
| <TextView | onView(withId(R.id.test_id)).check(noOv | Verify views do not | Any view, any |
| android:id=″@+id/test_id ″ | erlaps( )); | overlap | layout file |
| Test id (positioning | onView(withId(R.id.test_id)). | Verify positioning | Any view, any |
| information) is obtained by | check(matches(isDisplayed( ))). | of views relative to | layout file. |
| parsing the layout file | check(PositionAssertions.isBelow(withId | each other. | |
| | (R.id.test_id1))) | | |
| | .check(PositionAssertions.isAbove(withI | | |
| | d(R.id.test_id2))); | | |
| <TextView | public void renderWithEllipsizedText( ) { | Verify the view is | Text view with |
| android:id=″@+id/test_id ″ | onView(widiId(R.id.test_id)).check(matc | properly ellipsized | ellipsizable |
| .android:ellipsize=″end″> | hes(utilityMethodToCheckIfTextisEllipsi | on rendering. | text, any layout |
| | zed( ))); | | file. |
| | } | | |
| <TextView | public void renderWithFullMessage( ) { | Verify that text that | Text view with |
| android:id=″@+id/test_id” | onView(withId(R.id.test_id)). | is not supposed to | non-ellipsizable |
| | check(noEllipsizedText( ))); } | be ellipsized is not | text, any layout |
| | | ellipsized. | file. |
| <Button | assertView(R.id.test_id, (isDisplayed( )); | Verify view | Test depends on |
| android:id=″@+id/test_id” | | visibility logic is | boolean value of |
| ... | | properly performed, | the variable of |
| android:visibility=″@{data | assertView(R.id.test_id, | dataBindingObject. | the databinding |
| BindingObject.buttonVisibl | not(isDisplayed( ))); | buttonVisible is true | object. |
| e?View.VISIBLE:View.G | | and false, | |
| ONE}”> | | respectively. | |

Column 1 of Table 1 gives examples of types of elements that may be defined in the layout file 202, such as text views and buttons. Column 2 gives examples of test code that can be auto-generated by code generator software 216 based on the layout data shown in column 1. Column 3 explains the type(s) of tests performed by the test code of column 2. Column 4 indicates when the test code of column 2 can be used; for example, whether the test code has broad applicability or is limited to testing certain element types.

In an embodiment, code generator software 216 outputs test code 218 to an output file which is stored in computer memory. Test code 218 can be executed manually, for example by a programmer, or automatically, for example by a test automation system.

In an embodiment, test code 218 is output to a build process 220. Build process 220 is, for example, a computer-implemented process that prepares a software application for distribution. In an embodiment, build process 220 is a process that is initiated by build automation system 106, shown in FIG. 3, described below. As such, test code 218 and its execution can be incorporated into a commit pipeline, in an embodiment.

Example Networked System Environment

FIG. 3 is a block diagram that depicts an example computing system 300 arranged to operate automatic code generation system 102, code repository 104, build automation system 106, developer interface 130, mobile app user interface 132, in an embodiment. Computing system 300 includes computing device(s) 110, computing devices 140, 142, and display devices 170, 172, which are communicatively coupled to an electronic communications network 120.

Implemented in the devices 110, 140, 142, 170, 172 using computer software, hardware, or software and hardware, are processor-executable instructions, data structures, and digital data, stored in memory, which cooperate to provide the computer-implemented functionality shown in the drawings and described herein. For ease of discussion, these computer-implemented components are represented schematically in FIG. 3 as automatic code generation system 102, code repository 104, build automation system 106, developer interface 130, mobile app user interface 132.

“System” as used herein may refer to a single computer or network of computers and/or other devices. “Computing device” as used herein may refer to a computer or any other electronic device that is equipped with a processor. Although computing system 300 may be implemented with any number of automatic code generation system 102, code repository 104, build automation system 106, developer interface 130, mobile app user interface 132, computing device(s) 110, display devices 170, 172 and computing devices 140, 142, respectively, in this disclosure, these elements may be referred to in the singular form for ease of discussion.

Automatic code generation system 102, code repository 104, build automation system 106, developer interface 130, mobile app user interface 132 are shown as separate elements in FIG. 3 for ease of discussion but the illustration is not meant to imply that separation of these elements is required. The illustrated systems (or their functionality) and data stores may be divided over any number of physical systems, including a single physical computer system, and can communicate with each other in any appropriate manner.

Developer interface 130 and mobile app user interface 132 each may be implemented using a Web server computer that communicates with Web browser software running on computing devices 140, 142. Interfaces 130, 132 enable access to different portions of the functionality of computing system 300, by computing devices 140, 142. For example, web pages containing tests generated by automatic code generation system 102 may be displayed in developer interface 130 using web browser software and runtime specifications of layout file 202 may be used to render one or more views of mobile app user interface 132, for example in a sandbox or a simulation environment in which the tests that are automatically generated by system 102 may be run.

Portions of the illustrative automatic code generation system 102, code repository 104, build automation system 106, developer interface 130, mobile app user interface 132 may be implemented using web-based software applications and hosted by a hosting service (not shown). For example, portions of developer interface 130, mobile app user interface 132 and portions of automatic code generation system 102, code repository 104 and build automation system 106, may be implemented as client-side and server-side portions, respectively, of an online service. In an embodiment, portions of each of developer interface 130 and mobile app user interface 132 are implemented in a web browser that can execute on computing devices 140, 142, respectively.

In some embodiments, each of computing devices 140, 142 is a client-side computing device or set of cooperating computing devices, such as a smart phone, tablet computer, wearable or body-mounted device, smart appliance, laptop machine, or combination of any of such devices, and computing device 110 is a server-side computing device such as a server computer or network of server computers accessible by the Internet, for example in a public or private cloud. As illustrated in FIG. 3, each of display devices 170, 172 is implemented in a computing device 140, 142, respectively, but may be implemented as a separate device or as part of another device, or as multiple networked display devices, in other implementations.

Automatic code generation system 102 includes one or more computers upon which code generator software 216 is implemented, in an embodiment. Automatic code generation system 102 may implemented as a network service of network 120 that is accessible to one or more programmers and/or development teams. For example, automatic code generation system 102 may be implemented as an enterprise-wide software development resource.

Code repository 104 includes one or more computers upon which software application code is stored. In an embodiment, layout files 202 and test schema 210 are stored in code repository 104. Code repository 104 may implemented as a network service that is accessible to one or more programmers and/or development teams in addition to being accessible to automatic code generation system 102, via network 120. An example of a code repository that may be used in an embodiment is GITHUB.

Build automation system 106 includes one or more computers upon which build automation software may be implemented. Build automation system 106 may implemented as a network service that is accessible to one or more programmers and/or development teams in addition to being accessible to automatic code generation system 102, via network 120. In an embodiment, code generator software 216 is implemented as a plug-in to build automation system 106. Examples of build automation systems that may be used in some embodiments include GRADLE and MAVEN.

Network 120 may be implemented on any medium or mechanism that provides for the exchange of data between the devices that are connected to the network. Examples of network 120 include, without limitation, a network such as a Local Area Network (LAN), Wide Area Network (WAN), Ethernet or the Internet, or one or more terrestrial, satellite or wireless links. Network 120 may include a combination of networks, such as a combination of wired and wireless networks, as needed to enable communications between the computing device(s) 110, 140, 142.

Computing devices 140, 142 operate interfaces 130, 132, respectively, to establish logical connection(s) over network 120 with portions of automatic code generation system 102, code repository 104, and build automation system 106, at various times as needed for the operation of computing system 300.

Code Examples

FIG. 4A and FIG. 4B are examples of machine-readable code, in an embodiment.

FIG. 4A shows an example of an automatic test generator plug-in 400A. Line 402 of plug-in 400A identifies the plug-in and instructs a build automation system 106 to apply the plug-in. Line 404 identifies the path of layout file(s) that are to be auto-tested. Line 406 identifies the path of the test schema file. As indicated above, the test schema file includes various types of tests that are to be performed on the elements of the layouts that are located at the path identified in line 404. Line 408 specifies the path of an output location at which the tests that are auto-generated by the plug-in are to be stored.

FIG. 4B shows an example of a test schema 400B. Line 452 of test schema 400B identifies the test type. Here, the test type is “text,” which maps to text fields of text views of the layout file 202 (assuming that layout file 202 includes one or more text views and text fields). Metatags 454, 458 identify a test input 456. Test input 456 is data, for example an alphanumeric string, that is to be input to a text field in order to verify that the text field handles the input properly in terms of the on-screen rendering of the text field. Test schema 400B further shows additional examples of test inputs identified by metatags, including a 100-character string, a numeric string, a string with special characters, and an empty string. Each test input corresponds to a separate test case for which test code is to be generated by code generator software 216 for a particular text field. It should be understood that the illustrated test inputs are only examples and any number of different test types and test inputs may be used, in accordance with the requirements of a particular design or implementation of the disclosed technologies.

In operation of one embodiment, code generator software 216 maps the test inputs of test schema 400B to a text field that is identified in a layout file, and generates test code that when executed causes each of the test inputs to be applied to the text field when or in response to the text field being rendered on-screen. The test code includes an API call to obtain the current system state after rendering of the text field and inputting of the test input. The test code includes code that compares the current system state to the expected system state as determined from the layout file. Based on this comparison of the current system state to the expected system state, the test code is able to determine and output an indication as to whether the test was completed successfully.

Implementation Example—Hardware Overview

According to one embodiment, the techniques described herein are implemented by one or more computing devices. For example, portions of the disclosed technologies may be at least temporarily implemented on a network including a combination of one or more server computers and/or other computing devices. The computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, or FPGAs with custom programming to accomplish the described techniques.

The computing devices may be server computers, personal computers, or a network of server computers and/or personal computers. Illustrative examples of computers are desktop computer systems, portable computer systems, handheld devices, mobile computing devices, wearable devices, body mounted or implantable devices, smart phones, smart appliances, networking devices, autonomous or semi-autonomous devices such as robots or unmanned ground or aerial vehicles, or any other electronic device that incorporates hard-wired and/or program logic to implement the described techniques.

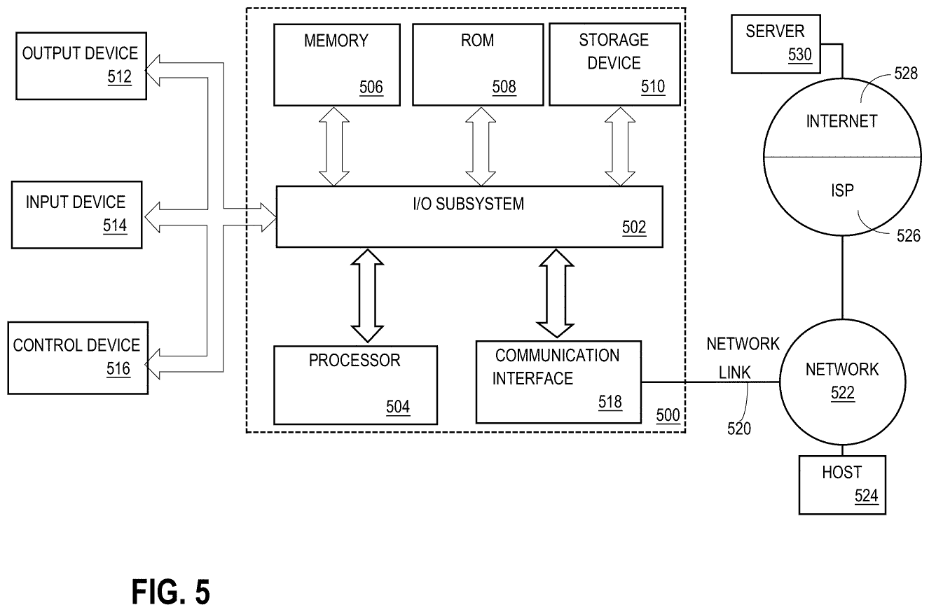

For example, FIG. 5 is a block diagram that illustrates a computer system 500 upon which an embodiment of the present invention may be implemented. Components of the computer system 500, including instructions for implementing the disclosed technologies in hardware, software, or a combination of hardware and software, are represented schematically in the drawings, for example as boxes and circles.

Computer system 500 includes an input/output (I/O) subsystem 502 which may include a bus and/or other communication mechanism(s) for communicating information and/or instructions between the components of the computer system 500 over electronic signal paths. The I/O subsystem may include an I/O controller, a memory controller and one or more I/O ports. The electronic signal paths are represented schematically in the drawings, for example as lines, unidirectional arrows, or bidirectional arrows.

One or more hardware processors 504 are coupled with I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor.

Computer system 500 also includes a memory 506 such as a main memory, which is coupled to I/O subsystem 502 for storing information and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, render computer system 500 into a special-purpose machine that is customized to perform the operations specified in the instructions.

Computer system 500 further includes a non-volatile memory such as read only memory (ROM) 508 or other static storage device coupled to I/O subsystem 502 for storing static information and instructions for processor 504. The ROM 508 may include various forms of programmable ROM (PROM) such as erasable PROM (EPROM) or electrically erasable PROM (EEPROM). A persistent storage device 510 may include various forms of non-volatile RAM (NVRAM), such as flash memory, or solid-state storage, magnetic disk or optical disk, and may be coupled to I/O subsystem 502 for storing information and instructions.

Computer system 500 may be coupled via I/O subsystem 502 to one or more output devices 512 such as a display device. Display 512 may be embodied as, for example, a touch screen display or a light-emitting diode (LED) display or a liquid crystal display (LCD) for displaying information, such as to a computer user. Computer system 500 may include other type(s) of output devices, such as speakers, LED indicators and haptic devices, alternatively or in addition to a display device.

One or more input devices 514 is coupled to I/O subsystem 502 for communicating signals, information and command selections to processor 504. Types of input devices 514 include touch screens, microphones, still and video digital cameras, alphanumeric and other keys, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be implemented as a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

Computer system 500 may implement the techniques described herein using customized hard-wired logic, one or more ASICs or FPGAs, firmware and/or program logic which in combination with the computer system causes or programs computer system 500 to operate as a special-purpose machine. According to one embodiment, the techniques herein are performed by computer system 500 in response to processor 504 executing one or more sequences of one or more instructions contained in memory 506. Such instructions may be read into memory 506 from another storage medium, such as storage device 510. Execution of the sequences of instructions contained in memory 506 causes processor 504 to perform the process steps described herein. In alternative embodiments, hard-wired circuitry may be used in place of or in combination with software instructions.

The term “storage media” as used in this disclosure refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage device 510 either before or after execution by processor 504.

Computer system 500 also includes a communication interface 518 coupled to bus 502. Communication interface 518 provides a two-way data communication coupling to network link(s) 520 that are directly or indirectly connected to one or more communication networks, such as a local network 522 or a public or private cloud on the Internet. For example, communication interface 518 may be an integrated-services digital network (ISDN) card, cable modem, satellite modem, or a modem to provide a data communication connection to a corresponding type of communications line, for example a coaxial cable or a fiber-optic line or a telephone line. As another example, communication interface 518 may include a local area network (LAN) card to provide a data communication connection to a compatible LAN. Wireless links may also be implemented. In any such implementation, communication interface 518 sends and receives electrical, electromagnetic or optical signals over signal paths that carry digital data streams representing various types of information.

Network link 520 typically provides electrical, electromagnetic, or optical data communication directly or through one or more networks to other data devices, using, for example, cellular, Wi-Fi, or BLUETOOTH technology. For example, network link 520 may provide a connection through a local network 522 to a host computer 524 or to other computing devices, such as personal computing devices or Internet of Things (IoT) devices and/or data equipment operated by an Internet Service Provider (ISP) 526. ISP 526 provides data communication services through the world-wide packet data communication network commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

### Additional Examples

Illustrative examples of the technologies disclosed herein are provided below. An embodiment of the technologies may include any of the examples described below.

In an example 1, a method includes receiving, by a code generator software, digital data identifying a particular layout file and a test schema; where the particular layout file includes runtime specifications for a particular user interface; where the test schema identifies inputs to be used to test renderings of a plurality of different user interfaces; automatically by the code generator software, creating, directly from the particular layout file and the test schema, machine-readable code representing tests; where the tests are executable to validate a rendering of the particular user interface by a mobile device operating system; where creating the machine-readable code includes mapping the inputs to the runtime specifications; where the method is performed by one or more computing devices.

An example 2 includes the subject matter of example 1, further including extracting, from the particular layout file, digital data that identifies a plurality of testable elements including any one or more of the following: a view, a spatial arrangement of views, a temporal order of views, a graphical element, an interactive element, an attribute of a view, an attribute of a graphical element, an attribute of an interactive element. An example 3 includes the subject matter of example 2, where the test schema contains digital data that identifies an element type, a test type associated with the element type, and an input associated with the test type. An example 4 includes the subject matter of example 3, where the code generator software receives as parameters the digital data that identifies the plurality of testable elements of the particular layout file and maps one or more of the parameters to the element type of the test schema. An example 5 includes the subject matter of any of examples 1-4, where the code generator software is implemented as a plugin for a build process. An example 6 includes the subject matter of any of examples 1-5, where the code generator software identifies an application program interface (API) associated with the mobile device operating system and generates a test that uses the API to obtain current state data from the mobile device operating system. An example 7 includes the subject matter of example 6, where the test includes computer code that when executed is to analyze the current state data to determine whether the test has been completed successfully. An example 8 includes the subject matter of any of examples 1-7, where the tests are executable to, using the inputs identified in the test schema, validate, for the particular layout file, on-screen characteristics of the particular user interface including any one or more of the following: a visual appearance of an element, a size of an element, a shape of an element, a location of an element, an international compatibility of an element, a color blind compatibility of an element. An example 9 includes the subject matter of any of examples 1-8, where the code generator software is implemented as a network service that accesses a code repository to obtain the particular layout file and the test schema. An example 10 includes the subject matter of any of examples 1-9, where the mobile device operating system is any one or more of the following: an open source operating system, an ANDROID operating system.

In an example 11, a computer program product includes one or more non-transitory computer-readable storage media including instructions which, when executed by one or more processors, cause: receiving, by a code generator software, digital data identifying a particular layout file and a test schema; where the particular layout file includes runtime specifications for a particular user interface; where the test schema identifies inputs to be used to test renderings of a plurality of different user interfaces; automatically by the code generator software, creating, directly from the particular layout file and the test schema, machine-readable code representing tests; where the tests are executable to validate a rendering of the particular user interface by a mobile device operating system; where creating the machine-readable code includes mapping the inputs to the runtime specifications.

An example 12 includes the subject matter of example 11, where the instructions further cause extracting, from the particular layout file, digital data that identifies a plurality of testable elements including any one or more of the following: a view, a spatial arrangement of views, a temporal order of views, a graphical element, an interactive element, an attribute of a view, an attribute of a graphical element, an attribute of an interactive element. An example 13 includes the subject matter of example 12, where the test schema contains digital data that identifies an element type, a test type associated with the element type, and an input associated with the test type. An example 14 includes the subject matter of example 13, where the code generator software receives as parameters the digital data that identifies the plurality of testable elements of the particular layout file and maps one or more of the parameters to the element type of the test schema. An example 15 includes the subject matter of any of examples 11-14, where the code generator software is implemented as a plugin for a build process. An example 16 includes the subject matter of any of examples 11-15, where the code generator software identifies an application program interface (API) associated with the mobile device operating system and generates a test that uses the API to obtain current state data from the mobile device operating system. An example 17 includes the subject matter of example 16, where the test includes computer code that when executed is to analyze the current state data to determine whether the test has been completed successfully. An example 18 includes the subject matter of any of examples 11-17, where the tests are executable to, using the inputs identified in the test schema, validate, for the particular layout file, on-screen characteristics of the particular user interface including any one or more of the following: a visual appearance of an element, a size of an element, a shape of an element, a location of an element, an international compatibility of an element, a color blind compatibility of an element. An example 19 includes the subject matter of any of examples 11-18, where the code generator software is implemented as a network service that accesses a code repository to obtain the particular layout file and the test schema. An example 20 includes the subject matter of any of examples 11-19, where the mobile device operating system is any one or more of the following: an open source operating system, an ANDROID operating system.

General Considerations

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used in this disclosure the terms “include” and “comprise” (and variations of those terms, such as “including,” “includes,” “comprising,” “comprises,” “comprised” and the like) are intended to be inclusive and are not intended to exclude further features, components, integers or steps.

References in this document to “an embodiment,” etc., indicate that the embodiment described or illustrated may include a particular feature, structure, or characteristic, but every embodiment may not necessarily include the particular feature, structure, or characteristic. Such phrases are not necessarily referring to the same embodiment. Further, when a particular feature, structure, or characteristic is described or illustrated in connection with an embodiment, it is believed to be within the knowledge of one skilled in the art to effect such feature, structure, or characteristic in connection with other embodiments whether or not explicitly indicated.

Various features of the disclosure have been described using process steps. The functionality/processing of a given process step could potentially be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features and components mentioned or evident from the text or drawings. These different combinations constitute various alternative aspects of the embodiments.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method, comprising:
receiving, by a code generator software, digital data identifying a particular layout file and a test schema;
wherein the particular layout file comprises runtime specifications for a particular user interface;
wherein the test schema identifies inputs to be used to test renderings of a plurality of different user interfaces;
automatically by the code generator software, creating, directly from the particular layout file and the test schema, machine-readable code representing tests;
wherein the tests are executable to validate a rendering of the particular user interface by a mobile device operating system;
wherein creating the machine-readable code comprises mapping the inputs to the runtime specifications;
wherein the method is performed by one or more computing devices.

2. The method of claim 1, further comprising extracting, from the particular layout file, digital data that identifies a plurality of testable elements including any one or more of the following: a view, a spatial arrangement of views, a temporal order of views, a graphical element, an interactive element, an attribute of a view, an attribute of a graphical element, an attribute of an interactive element.

3. The method of claim 2, wherein the test schema contains digital data that identifies an element type, a test type associated with the element type, and an input associated with the test type.

4. The method of claim 3, wherein the code generator software receives as parameters the digital data that identifies the plurality of testable elements of the particular layout file and maps one or more of the parameters to the element type of the test schema.

5. The method of claim 1, wherein the code generator software is implemented as a plugin for a build process.

6. The method of claim 1, wherein the code generator software identifies an application program interface (API) associated with the mobile device operating system and generates a test that uses the API to obtain current state data from the mobile device operating system.

7. The method of claim 6, wherein the test includes computer code that when executed is to analyze the current state data to determine whether the test has been completed successfully.

8. The method of claim 1, wherein the tests are executable to, using the inputs identified in the test schema, validate, for the particular layout file, on-screen characteristics of the particular user interface including any one or more of the following: a visual appearance of an element, a size of an element, a shape of an element, a location of an element, an international compatibility of an element, a color blind compatibility of an element.

9. The method of claim 1, wherein the code generator software is implemented as a network service that accesses a code repository to obtain the particular layout file and the test schema.

10. The method of claim 1, wherein the mobile device operating system is any one or more of the following: an open source operating system, an ANDROID operating system.

11. A computer program product comprising one or more non-transitory computer-readable storage media comprising instructions which, when executed by one or more processors, cause:
receiving, by a code generator software, digital data identifying a particular layout file and a test schema;
wherein the particular layout file comprises runtime specifications for a particular user interface;
wherein the test schema identifies inputs to be used to test renderings of a plurality of different user interfaces;
automatically by the code generator software, creating, directly from the particular layout file and the test schema, machine-readable code representing tests;
wherein the tests are executable to validate a rendering of the particular user interface by a mobile device operating system;
wherein creating the machine-readable code comprises mapping the inputs to the runtime specifications.

12. The computer program product of claim 11, wherein the instructions further cause extracting, from the particular layout file, digital data that identifies a plurality of testable elements including any one or more of the following: a view, a spatial arrangement of views, a temporal order of views, a graphical element, an interactive element, an attribute of a view, an attribute of a graphical element, an attribute of an interactive element.

13. The computer program product of claim 12, wherein the test schema contains digital data that identifies an element type, a test type associated with the element type, and an input associated with the test type.

14. The computer program product of claim 13, wherein the code generator software receives as parameters the digital data that identifies the plurality of testable elements of the particular layout file and maps one or more of the parameters to the element type of the test schema.

15. The computer program product of claim 11, wherein the code generator software is implemented as a plugin for a build process.

16. The computer program product of claim 11, wherein the code generator software identifies an application program interface (API) associated with the mobile device operating system and generates a test that uses the API to obtain current state data from the mobile device operating system.

17. The computer program product of claim 16, wherein the test includes computer code that when executed is to analyze the current state data to determine whether the test has been completed successfully.

18. The computer program product of claim 11, wherein the tests are executable to, using the inputs identified in the test schema, validate, for the particular layout file, on-screen characteristics of the particular user interface including any one or more of the following: a visual appearance of an element, a size of an element, a shape of an element, a location of an element, an international compatibility of an element, a color blind compatibility of an element.

19. The computer program product of claim 11, wherein the code generator software is implemented as a network service that accesses a code repository to obtain the particular layout file and the test schema.

20. The computer program product of claim 11, wherein the mobile device operating system is any one or more of the following: an open source operating system, an ANDROID operating system.
